(19) United States
(12) Patent Application Publication
(10) Pub. No.: US 2005/0015335 A1
(43) Pub. Date: Jan. 20, 2005

(54) Charitable purpose investment securities ("CPIS")

(76) Inventor: Patrick John Howard, Sammamish, WA (US)

Correspondence Address: PATRICK JOHN HOWARD, 250 223RD PLACE NE, SAMMAMISH, WA, 98074, US

(21) Appl. No.: 10/857,130

(22) Filed: May 28, 2004

Related U.S. Application Data
(60) Provisional application No. 60/474,763, filed on Jun. 2, 2003.

(51) Int. Cl. G06F 17/60

(52) U.S. Cl. 705/39

(57) ABSTRACT

CPIS is a unique financing application benefiting charitable organizations as Borrowers. By issuing bonds (or other debt financing instruments, such as loans, leases, etc.) structured as interest-only paying debt service obligations over a specified term, without the repayment of principal (the principal amount is gifted by the Contributor as an investor/donor through a trust vehicle or other means back to the Borrower), a Borrower effectively creates the lowest cost of capital in comparison to other debt structures requiring the repayment of both principal and interest. While Borrower benefits are significant, CPIS further benefits Contributors through the combination of tax benefits, interest income, and reinvestment earnings on the interest income. This interest income may be further leveraged by the Contributor for enhanced charitable giving opportunities and/or investment returns. CPIS may be structured as taxable or tax-exempt debt obligations and carry a security interest in the project financed by the Borrower. CPIS is a true breakthrough in financial structural design for the capital markets, for Borrowers and for Contributors. CPIS has the potential to redefine the manner in which charitable organizations look to raise funding for projects by combining charitable giving, philanthropy and investment through the issuance of CPIS.

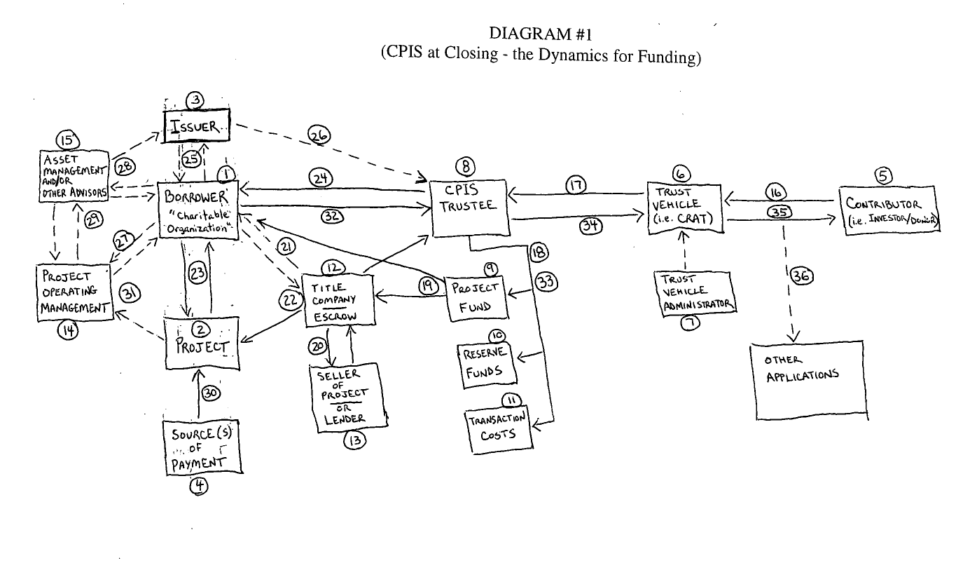

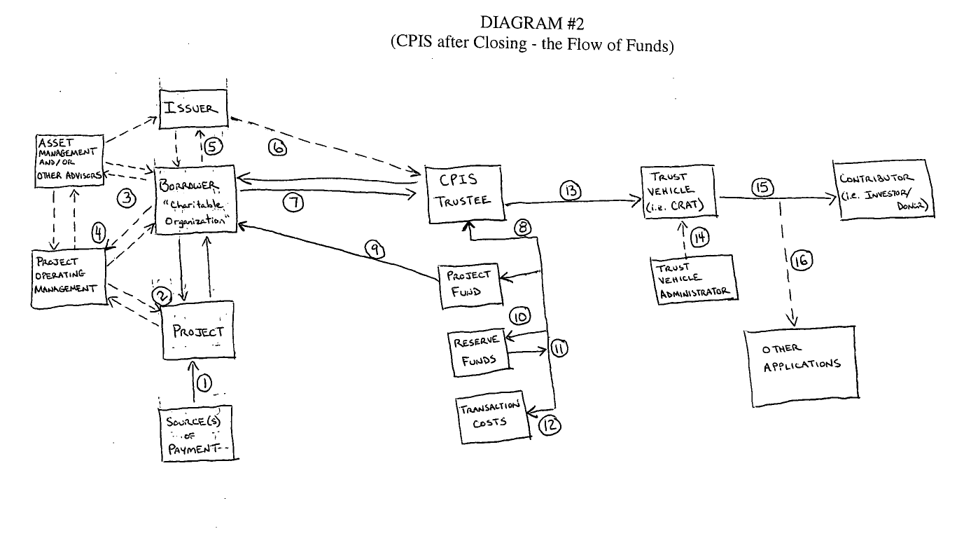

### CROSS REFERENCE TO RELATED APPLICATION

This application claims the benefit of U.S. Provisional Application No. 60/474,763 filed Jun. 2, 2003, entitled Charitable Purpose Investment Securities (“CPIS”), which is incorporated herein by reference.

### STATEMENT REGARDING FEDERALLY SPONSORED RESEARCH OR DEVELOPMENT

Not applicable.

### REFERENCE TO A SEQUENCE LISTING, A TABLE, OR A COMPUTER PROGRAM LISTING COMPACT DISC APPENDIX

Not applicable.

### BACKGROUND OF THE INVENTION

The invention relates to financial or business practices.

Charitable organizations, including non-profits and governmental agencies (hereinafter referred to as “charitable organization” or “charitable organizations”), often use debt to finance their projects. These projects may include anything that supports the charitable purpose of the charitable organization, such as housing, hospitals, universities, recreational fields, school facilities, development, etc. and may involve new construction, acquisition, rehabilitation, refinancing of existing debt, funding operations, funding endowments, etc. (collectively herein referred to as “Project” or “Projects”).

In addition to using debt, typically in the form of bank loans, taxable and/or tax-exempt bonds, or other loans, charitable organizations may also rely on charitable gifts, donations, philanthropy, and federal, state, or local grants and/or subsidies. Also, to the extent the charitable organization has cash reserves or other assets convertible into cash they may choose to use these resources to help fund their Project.

Charitable organizations find that they oftentimes have to use a combination of available resources to fully fund their Projects, versus relying solely on debt financing or raising donations from charitable contributors through a capital campaign. While debt financings in this manner can be very restrictive, costly and time consuming to receive the funding, oftentimes requiring additional collateral and guarantees, raising large capital donations is also typically a lengthy process with many costs and challenges, thereby requiring interim financing to move forward on a Project immediately.

However, the inability to rely solely on debt creates a gap or funding shortfall that needs a solution in order to proceed with the Project. In the conventional markets, a borrower may seek a partner or equity investor to solve a financing shortfall or gap, but for charitable organizations this may not be an option due to federal and state rules and regulations governing charitable organizations, thus creating a very difficult and somewhat unique financial challenge for a charitable organization.

CPIS was created as a means to fill this funding gap. CPIS (Charitable Purpose Investment Securities) brings two separate and distinct markets, the capital markets and the philanthropic markets, together under one financing structure. The end result of CPIS provides a win-win solution for both the charitable organization as a borrower (hereinafter referred to as “Borrower” or “Borrowers”) through the capital markets and the contributor (an individual, corporation, foundation, or other entity that can benefit from CPIS, hereinafter referred to as “Contributor” or “Contributors”) through the philanthropic markets. This approach has never before been applied and therefore provides a whole new approach, previously unavailable to Borrowers and Contributors alike.

### BRIEF SUMMARY OF THE INVENTION

Charitable Purpose Investment Securities (“CPIS”) have been designed as a financing device for use by those Borrowers able to provide charitable gift receipts (such as, but not limited to, governmental entities, non-profit organizations and others identified as such by the United States Internal Revenue Service (the “IRS”)). By issuing CPIS Borrowers are able to create the necessary financing for Projects that aid in the fulfillment of their charitable purpose. CPIS are purchased with cash provided by Contributors who stand to benefit from a charitable gift deduction on their federal, state and/or local income tax returns (“Income Tax Returns”) in addition to benefiting from receiving interest income over the term of the CPIS; Contributors must qualify to purchase CPIS in accordance with federal and state securities and/or banking laws and may include an individual and/or a legal entity such as a corporation, a partnership, or a trust vehicle. There are many trust vehicles that can be utilized by Contributors, such as, but not exclusively, Charitable Remainder Trusts, Charitable Remainder Uni-Trusts, Charitable Remainder Annuity Trusts, etc. (hereinafter referred to as “trust vehicles”). While a Charitable Remainder Annuity Trust (hereinafter referred to as a “CRAT”) has many advantageous features that are beneficial to the CPIS structure, and will be used to demonstrate the application of CPIS below, it is not the only trust vehicle that can be utilized by a Contributor.

CPIS provides a unique approach to financing for Borrowers as charitable entities that has never before been applied. While Contributors benefit from making contributions on a charitable basis, thus receiving the income tax deduction associated with making a charitable contribution, they also earn a rate of interest on their CPIS investment principal amount over a set term. The CPIS structure allows Contributors to leverage their charitable gift by providing a return on their monetary gift amount. Contributors may then use this income towards additional charitable endeavors or for any other lawful purpose at their sole discretion. The interest earned on the CPIS may be either taxable or tax-exempt depending on the Borrower and the nature of the use of proceeds generated from the issuance of CPIS. Interest payments are to be made over the term of the CPIS as defined in the legal documents associated with the issuance of the CPIS. While the interest income is to be reported by Contributors on their respective Income Tax Returns for the year in which it is received, the principal portion of their investment is to be included on their Income Tax Returns as a charitable gift deduction in the year it is made, or carried forward as permitted under IRS regulations. At the final maturity date for the CPIS the interest payments cease, there is no longer any outstanding principal associated with the CPIS issue, and the Borrower obligations there under are terminated.

CPIS is designed to address the need for charitable organizations to raise Project capital in support of their mission.

CPIS is designed to maximize the impact of charitable gift giving dollars towards fulfilling a charitable organization's mission (making it possible for Contributors to contribute more at the same cost). CPIS is able to aid the Borrower by minimizing the financial demands it places on its Contributors by establishing a means by which to re-generate a Contributor's gift giving potential. CPIS offers a Borrower a lower cost of financing in comparison to traditional financing options. CPIS has built in investment protection through security interests and reserve funds. CPIS provide for program implementation through private-public partnerships with the financing component managed by a placement agent or licensed securities dealer when securities are involved.

### BRIEF DESCRIPTION OF THE DRAWINGS

Diagram #1 (CPIS at Closing—the Dynamics for Funding) represents an example of the many elements essential to the successful closing of a CPIS transaction.

Diagram #2 (CPIS after Closing—the Flow of Funds) represents an example of the flow of funds during the term of the CPIS, after a CPIS transaction closes.

### DETAILED DESCRIPTION OF THE INVENTION

The following describes CPIS by defining those items appearing in the two diagrams referenced above and further detailing the many components and applications of CPIS, including methods for its fundamental use, as well as for methods to enhance the ability to create even greater opportunities for Borrowers and Contributors alike.

Definitions of Diagram #1 (CPIS at Closing—the Dynamics for Funding) that help to describe the elements essential to the CPIS program are as follows—the number below refers to the number listed in the Diagram #1:
(1) Borrower is a non-profit, governmental entity, or other IRS qualified entity that intends to use proceeds from a CPIS issuance in a manner that is consistent with and supportive of its charitable purpose.
(2) Project is that project, whether an asset or other project, being financed by the proceeds from the CPIS as directed by the Borrower.
(3) Issuer may also by the Borrower, but otherwise is a separate entity that acts as a conduit on behalf of the Borrower for purposes of issuing the CPIS.
(4) Sources of payment may be from a single source or multiple sources as determined by the Borrower. Sources provide the cash flow that is to be applied towards the repayment of debt service required by the issuance of CPIS.
(5) Contributor to the trust vehicle may also be viewed as both an investor and a donor, since ultimately by funding the trust vehicle this Contributor is to receive interest payments based on the principal amount of the CPIS and is to receive a charitable gift tax benefit based on the gifting of all or a portion of the principal amount of the CPIS. Depending on the complexity and amount of the CPIS issuance, there may be one or more than one Contributor.
(6) The trust vehicle is a trust established by the Contributor, or on the Contributors behalf by its advisor(s), that is initially funded with cash and/or appreciable assets that are then liquidated for cash; while the expected trust vehicle is a CRAT, other types of trusts may be utilized by the Contributor. Depending on the complexity and amount of the CPIS issuance, there may be one or more than one trust, or a master trust with multiple Contributors that would each be assigned a participating interest percentage in the trust.
(7) A Trust Administrator is expected for each trust established under the CPIS structure. This entity shall perform its duties as outlined in the trust legal documents and in accordance with federal and state laws governing trusts.
(8) CPIS Trustee shall act as a fiduciary agent for the CPIS. The CPIS Trustee shall carry out those instructions within the CPIS Trust Indenture for the CPIS, including, but not limited to, funding all accounts held under the CPIS trust estate, receiving debt service payments from the Borrower (or as directed by the Borrower), and making all debt service payments on the CPIS as they become due and payable. A CPIS Trustee may be disregarded in the case of a direct placement of CPIS where CPIS have been structured as a loan versus a bond, as directed by the Contributor.
(9) Project Fund is that established within the CPIS Trust Indenture where the CPIS Trustee deposits CPIS proceeds that are to be used specifically for the Project that is being financed.
(10) Reserve Funds are to include all reserve funds established under the CPIS Trust Indenture. Reserve funds may include reserves for timely payment of debt service due on the CPIS, for supporting loss of revenue sources during periods of construction, and/or other adverse conditions that may affect the Project.
(11) Transaction Costs include all costs associated with a CPIS transaction, including, but not limited to, fees and expenses for the following:
   a. Placement agent (or licensed securities representative or broker-dealer)
   b. Legal counsel (for CPIS, for placement agent, for Borrower, for Issuer, for Contributor, for CPIS Trustee, for Trust Administrator, for tax issues, for rating agency, and for all other as necessary)
   c. Accountants
   d. Tax advisors
   e. Trustees (for CPIS and for trust vehicle)
   f. Issuer
   g. Other advisors
   h. Title company
   i. Escrow
   j. Third party reports
   k. Rating agency
   l. Asset management
   m. Credit enhancement
   n. Insurance premiums
   o. Other applicable fees and expenses relevant to CPIS transaction
(12) Title Company and Escrow would be necessary for CPIS transactions involving real estate. It would be expected, but not required, that the same entity would provide both of these services for a CPIS transaction.
(13) Seller of Project is an individual or entity that is selling the Project in the event of an acquisition by the Borrower. A lender would be the entity holding a loan or other debt instrument that will be repaid from the proceeds of the CPIS transaction.
(14) Project operating management is either an engaged third party entity or the Borrower.
(15) Asset management and/or other advisors are at the option of the Borrower and/or Issuer, and may be used to help with the oversight of the project.
(16) Contributor to the trust funds the trust vehicle with cash and/or appreciable assets that are to be converted into cash by the Trust Administrator prior to the trust purchasing the CPIS.
(17) It is expected that the cash within the trust vehicle will be used to purchase CPIS in order to provide the Borrower with the necessary funds to finance their Project. As a result of the purchase of CPIS the Trust Administrator and the Contributor will receive legal evidence of the purchase of CPIS.
(18) The CPIS Trustee upon receiving the cash from the Trust Administrator for purchase of the CPIS will be instructed pursuant to the CPIS documents to deposit said funds into a project fund, into reserve funds, and towards the payment of transaction costs.
(19) Funds within the project fund will be transferred from the CPIS Trustee to the Borrower or to the Title Company/Escrow for funding of the Project, be it for acquisition, refinancing and/or construction.
(20) The Title Company/Escrow will transfer funds it receives for an acquisition and/or a loan refinancing to either the seller of the Project being acquired or to the lender whose loan is to be paid.
(21) The Title Company/Escrow will transfer funds it receives to the Borrower, or to a third party as directed by the Borrower, for purposes of paying for construction or any other purpose. Any funds remaining in the escrow will also be transferred to the Borrower in order to close the escrow.
(22) Upon evidencing of the transfer of funds and completion of the recording of title, as appropriate, the Title Company will show evidence of such recording and transfer of title to the Borrower and the CPIS Trustee.
(23) Borrower is a charitable organization and is the owner or lessee of the Project.
(24) CPIS Trustee enters into a fiduciary agent relationship with the Borrower pursuant to the CPIS Trust Indenture and/or the Loan Agreement.
(25) When the Borrower and Issuer are not the same entity, a contractual relationship exists between the entities whereby the Issuer agrees to be the issuer of CPIS for the benefit of the Borrower.
(26) CPIS Trustee enters into a fiduciary agent relationship with the Issuer pursuant to the CPIS Trust Indenture and/or the Loan Agreement.
(27) In the event the Project is to be managed by a third party management entity, an operating agreement or management agreement will be established.
(28) In the event the Project is to have asset management or other advisory services provided by a third party entity or entities, proper agreements will need to be established.
(29) Asset management and/or other advisors will review Project information as supplied by the Project operating management on behalf of the Borrower and/or Issuer and report back to the Borrower and/or Issuer pursuant to terms and conditions within their respective agreements.
(30) The source or sources of payments that will be utilized by the Borrower to fulfill its debt service and fee obligations under CPIS may come in full or in part from the Project benefiting from the proceeds of the CPIS, or from some other identified source.
(31) If a third party project operating management is used then the sources from the Project being managed by this entity will be collected by this operating management entity and then either transferred to the Borrower or to the CPIS Trustee as instructed by the Borrower.
(32) Borrower is obligated to make full and timely payments for CPIS to the CPIS Trustee pursuant to the CPIS Trust Indenture and/or Loan Agreement.
(33) Upon receiving said funds from the Borrower the CPIS Trustee will have instructions pursuant to the CPIS Trust Indenture and/or Loan Agreement to deposit said funds into various funds and accounts, and to pay any fees and expenses.
(34) CPIS Trustee will forward CPIS debt service payments to the trust vehicle on a regularly scheduled basis and in their entirety, pursuant to the CPIS Trust Indenture and/or Loan Agreement.
(35) Pursuant to the trust vehicle documents, the Trust Administrator will distribute those funds received in the trust vehicle by the CPIS Trustee either directly to the Contributor or as directed by the Contributor towards other applications.
(36) Other applications may be established within the trust vehicle documents and/or directed by the Contributor upon receiving from the Trust Administrator, and may include such things as: charitable giving either to the Borrower or to any other charitable organization as beneficiary, the purchase of insurance product (naming either a charitable organization or other party as beneficiary), financial and other investments, transfers to other trust vehicles, towards payment of taxes, or to satisfy any other needs of the Contributor.

Definitions of Diagram #2 (CPIS after Closing—the Flow of Funds) that help to describe the flow of funds for CPIS after the successful closing of a CPIS transaction through the end of the CPIS term are as follows:
(1) Funds that comprise the sources of sources of payments that come entirely or in part from the Project, or from any other identifiable source or sources, are for the benefit of the Borrower in order to satisfy its obligation of CPIS debt service and fees payments.
(2) Funds that flow from the source or sources are collected by the Borrower directly or by a project operating management entity pursuant to an agreement between that entity and the Borrower.
(3) In the event there are third party entities associated with a Project for operating management, asset management or other advisory, agreements will exist with the Borrower describing fees for services rendered and how these fees are to be paid.
(4) The project operating management will provide information on the financial performance of the Project and other relevant information to the Borrower and its asset management and other advisors as appropriate.
(5) The Borrower will provide information to the Issuer of the CPIS, unless the Borrower is the Issuer of the CPIS, on a regular scheduled basis pursuant to their agreement.
(6) The Issuer and/or the Borrower shall be responsible for providing disclosure documentation to the CPIS Trustee as per the CPIS Trust Indenture and/or Loan Agreement and/or Regulatory Agreement.
(7) Borrower shall also be responsible for providing funds to the CPIS Trustee, as per the CPIS Trust Indenture and/or Loan Agreement, for the full and timely payment of CPIS debt service and fees.
(8) Upon receiving said funds from the Borrower the CPIS Trustee will have instructions pursuant to the CPIS Trust Indenture and/or Loan Agreement to deposit said funds into various funds and accounts, and to pay any fees and expenses.
(9) Funds on deposit in the project fund shall be distributed by the CPIS Trustee to the Borrower, or as directed by the Borrower, until fully disbursed for purposes related to the Project or as otherwise permitted within the CPIS Trust Indenture and/or Loan Agreement.
(10) CPIS Trust Indenture and/or Loan Agreement will require the CPIS Trustee to make scheduled deposits into reserves, or to replenish reserves otherwise having previously experienced withdraws of funds, back to their required amounts.
(11) CPIS Trust Indenture and/or Loan Agreement may stipulate that the CPIS Trustee apply interest earnings on funds held in the reserves to be used for CPIS debt service, payment of fees and expenses, or directed to the Project fund for application as defined in the CPIS Trust Indenture and/or Loan Agreement.
(12) CPIS Trust Indenture and/or Loan Agreement will require the CPIS Trustee to make scheduled payments of transaction costs, fees and expenses for services rendered during the term while the CPIS are outstanding.
(13) CPIS Trustee will forward CPIS debt service payments to the trust vehicle, as the registered owner of the CPIS, and disclosure information to the Trust Administrator, on behalf of the trust vehicle, on a regularly scheduled basis and in their entirety, pursuant to the CPIS Trust Indenture and/or Loan Agreement.
(14) Disclosure documents will be forwarded by the Trust Administrator to the Contributor upon their receipt by the Trust Administrator from the CPIS Trustee.
(15) Pursuant to the trust vehicle documents, the Trust Administrator will distribute those funds received in the trust vehicle by the CPIS Trustee either directly to the Contributor or as directed by the Contributor towards other applications.
(16) Other applications may be established within the trust vehicle documents and/or directed by the Contributor upon receiving from the Trust Administrator, and may include such things as: charitable giving either to the Borrower or to any other charitable organization as beneficiary, the purchase of insurance product (naming either a charitable organization or other party as beneficiary); financial and other investments, transfers to other trust vehicles, towards payment of taxes, or to satisfy any other needs of the Contributor.

Process of making and using CPIS:

CPIS issuance can be initiated in a number of ways by any party that has become familiar with its use and application. Typical initiators of a CPIS financing would include Borrowers, Contributors, investment bankers, placement agents, commercial bankers, real estate professionals, financial advisors, trustees, investors, consultants, accountants, lawyers, insurance agents, tax specialists, and potentially many others. While any one or more of the above mentioned entities could be responsible for initiating a CPIS structure, it is expected, but not always a requirement depending on how CPIS is structured, that an issue would be structured and closed with the assistance of an individual or individuals whom are licensed securities representatives (i.e. having a Series 7 or other license allowing for such representation) associated with a securities broker dealer or other qualified entity authorized to sell financial securities.

It would be expected that when electing an optimum financing structure for a Borrower that CPIS would be considered. While there may be other uses for CPIS it is expected that its frequent use will include providing financing capital for any of the following Projects: the acquisition of existing assets, the construction of new assets, or the refinancing of currently owned assets. While these assets are most likely to be revenue producing assets, since they provide an identifiable and targeted source of funds for the payment of the interest rate obligations attributed to the CPIS, it may be possible to finance non-revenue producing assets, as long as there is an identifiable source of revenue available in which to make the scheduled interest rate payments on the CPIS.

While many Projects will be financed as one asset under a single CPIS issuance, it is expected that there will be both small and large pools consisting of multiple assets under a single CPIS issuance. Also, while it is expected that Projects will be identified prior to issuing a CPIS, it is not a requirement, thus allowing for the financing of multiple Projects initially unidentified at the time of the CPIS issuance.

When Projects are determined, the Borrower, with the assistance of those professionals necessary for successfully completing a CPIS issuance (i.e. investment bankers, lawyers, accountants, tax professionals, etc.), shall be responsible for reviewing all due diligence materials that are standard in the industry for the Project under consideration. Typical due diligence materials for a Project may include, but not be required or limited to, a preliminary title report, a survey, an appraisal, a market study, a physical condition report, an environmental report, a Project rent roll, a Project operating statement, an operating budget, a rehabilitation or construction budget, a pro form a cash flow, a sources and uses statement, and all other reports deemed necessary by those parties involved in the issuance or purchase of the CPIS.

Upon completion of the initial due diligence review the CPIS terms should be structured to determine the total issuance amount and the uses of the proceeds to be generated from the sale of the CPIS. Structure can exist in many forms, but will need to include at a minimum, the name of the Issuer, the name of the Borrower, the name of the Project, the issuance amount of the CPIS financing, an issuance date, interest payment dates, a final maturity date, an interest rate or rates, minimum investment amounts, tax status for interest payments, fees for a trustee and/or a servicer, form of delivery of CPIS, liquidity features, security, collateral, flow of funds, and any and all other requirements in accordance with both federal and state securities and lending laws; all of which will be displayed in a term sheet summary and/or an offering memorandum for disclosure.

CPIS is not only dependent on the structure and complete disclosure as referenced in the preceding paragraph, but is dependent on the Contributor and its preferred vehicle for purchasing CPIS. As mentioned before, one trust vehicle that would seem to provide an optimum result for a Contributor when purchasing CPIS is a CRAT. Separate CRAT documents will need to be established in conjunction with the CPIS documents in order to close a CPIS transaction. This document would state what the Contributor is placing into the CRAT, cash and/or other appreciated assets that need to be converted into cash, and further instructions on when and how the Trust Administrator is to disperse funds from the CRAT. Pursuant to laws governing a CRAT the instructions cannot require that the funds deposited be used to purchase CPIS, but it is the implied intent of the Contributor establishing the CRAT that said funds within the CRAT will be used for the sole purpose of funding CPIS for the benefit of the Borrower.

CPIS issues may be issued as the sole financing source for the Borrower or as one of many financing sources. One application that could benefit Borrowers would be to issue a sufficient amount of CPIS that are secured by residual receipts from a Project that could enable the Borrower to secure insurance or other credit enhancement or financial guarantees on bonds or loans that would be secured by a first lien deed of trust or other acceptable collateral security on the Project. The goal being that the Borrower could lower its effective borrowing costs of conventional debt sources by blending in CPIS for purposes of financing the Project.

A component of determining the structure is that of calculating the effective interest rate of the CPIS. This calculation can be measured by taking the amount of the charitable gift being made by the Contributor to the Borrower (i.e. the principal amount of the CPIS purchased) and multiplying that number by the applicable deduction rate (in the event the Contributor uses a trust vehicle to purchase the CPIS), and then multiplying that figure by the Contributor's applicable federal, state and local income tax rates combined (“Income Tax Rate”), to arrive at the Contributor's amount to be included as a charitable gift deduction on its Income Tax Return for that year in which its investment has been made, or carried forward and applied to future year tax returns as permitted under IRS regulations.

In addition, interest payments on the Contributor's CPIS may be forecasted in a proforma cash flow statement to determine the annual interest payments to be received over the entire term of the CPIS based on the principal amount of the CPIS investment. CPIS interest payments may be structured based on any payment frequency (i.e. weekly, monthly, quarterly, semi-annually, etc.), but in no event less than once per annum.

The interest rate of the CPIS, taking into consideration whether it is taxable or tax-exempt, should also be converted into a taxable equivalent rate based on the Contributor's Income Tax Rate in order to learn its total effect. In order to arrive at the Contributor's overall effective taxable equivalent interest rate, the following should be considered: the figure established as the Contributor's charitable gift deduction, divided by its CPIS investment amount, divided by the term of the CPIS.

Upon the Borrower completing the due diligence review and understanding the structure, the Issuer would then instruct the team of professionals to begin drafting the required CPIS legal documentation in order to effect documentation for the Borrower's board of directors or comparable governing body to approve a resolution for the financing being pursued, for marketing the sale of the CPIS through an offering memorandum or other industry accepted medium, and for effecting the successful legal closing of the CPIS issuance. Common legal documents associated with CPIS may include, but not be limited to: a trust indenture, a loan agreement, a servicing agreement, various legal opinions, a deed of trust, a residual receipts note, a management agreement, a title insurance policy, a Borrower's resolution, a placement and/or purchase agreement, a note, an offering memorandum and/or official statement, a regulatory agreement, a trust document (if a trust vehicle is being used by a Contributor to purchase CPIS), and other documents as deemed necessary by legal counsel, tax advisors and others involved in an issuance of CPIS.

Note that a Borrower can choose to identify and confirm the Contributors prior to instructing the team of professionals to begin drafting legal documents, etc. as described above.

The marketing process of a CPIS issue will be targeted toward all entities that may be a potential Contributor (i.e. individuals, corporations, foundations, etc.), that would seem most likely to benefit from participating in the CPIS structure. The Contributors will be expected to have a high level of sophistication in both investing and philanthropy, and may use professionals to assist them in their evaluation of CPIS and to assist them in setting up a vehicle that best represents their interest in CPIS. For example, it is expected that a common vehicle of choice to be used by Contributors will be a Charitable Remainder Trust, or more specifically a CRAT.

For illustrative purposes, a CRAT will be used as the purchaser to explain one way in which the CPIS structure can work for both the Borrower and the Contributor.

With the assistance of professional tax planning advisors, a CRAT is to be established in which the Contributor funds with cash, and/or with appreciable assets that are to be converted into cash within the CRAT, an amount equal to its purchase of CPIS.

The CRAT will then be the purchaser of record when its Trust Administrator purchases the CPIS from the Issuer (or designated CPIS Trustee on behalf of the Issuer and/or Borrower), the issue closes, and the CPIS are owned by the CRAT. While the CRAT could hold the CPIS and receive the obligated interest payments directly, it is expected that a CPIS Trustee and/or servicer will be identified in the CPIS legal documents to collect payments from the Borrower as a fiduciary agent and then make payments to the CRAT as the bondholder.

As a result of a successful closing of a CPIS issuance and the subsequent gifting of the principal amount of the CPIS by the CRAT, the Contributor of the CRAT may apply its investment in the CRAT and subsequent gift to the Borrower towards a charitable gift deduction on its Income Tax Returns for that tax year in which the investment was made, or choose to carry forward all or part of this tax benefit to apply towards its future Income Tax Returns.

In the event the Contributor uses something other than a CRAT or other trust vehicle, the Contributor may buy self-canceling CPIS directly from the Borrower and take a charitable tax deduction under the “bargain sale” principles, for example.

In addition, upon the CRAT receiving interest payments in accordance with the terms of the CPIS, and the Trust Administrator distributing those interest payments on to the Contributor, the Contributor must declare those interest payments received on its Income Tax Returns for that year in which the distributions are made. Depending on the tax status of the interest payments, whether they are taxable or tax-exempt, the Contributor shall file such payments appropriately.

The Contributor is further able, but not required, to leverage its investment by redistributing the interest payments received towards another charitable gift or other investment. The effect on the overall effective interest rate can be significant as further examined below.

Again, this calculation can be measured by taking the amount of the charitable gift being made by the Contributor to the Borrower (i.e. the principal amount of the CPIS purchased) and multiplying that number by the applicable deduction rate (for a CRAT it is the present value of the remainder interest in the annuity trust expressed as a percentage factor—this figure is partly based on the discount rate as reported under Internal Revenue Code Section 7520(a)) and then multiplying that figure by the Contributor's applicable federal, state and local income tax rates combined (i.e. Income Tax Rate), to arrive at the Contributor's amount to be included as a charitable gift deduction on its Income Tax Return for that year in which its investment has been made, or carried forward and applied to future year tax returns as permitted under IRS regulations.

An illustrative example of how this formula is computed as described above is as follows: CPIS principal amount of $1,165,000; a tax-exempt CPIS interest rate of 5.00% (fixed rate); a 10-year final maturity term; the Contributor uses a CRAT to purchase the CPIS; a CRAT deduction, rate of 58.460% (this factor, described above, is only applied due to the fact a CRAT is being utilized and may not be applicable to other vehicles used to purchase CPIS); and the Contributor is an individual with an Income Tax Rate of 44.3%, representing a federal income tax rate of 35% plus a California State resident personal income tax rate of 9.3%.

Total eligible deductible amount of CPIS tax benefit from Contributor's gift of the principal amount: $1,165,000*58.460%=$681,059;
Amount of deduction reported on Contributor's income tax return: $681,059*44.3%=$301,709;
Tax-exempt interest rate's taxable equivalent: 5.00%/(1-44.3%)=8.98%;
Overall effective interest rate: 8.98%+($301,709/$1,165,000/10)=11.57%.

For the example described above, a CRAT was assumed as the purchaser of CPIS, and the CPIS were assumed to be in the form of tax-exempt bonds. By utilizing this CPIS structure with the Contributor using a CRAT, it is able to further leverage its original charitable gift contribution by an additional 50% as a result of receiving tax-exempt interest payments over the term of the CPIS.

This assumes that the Contributor's investment is made from taxable income dollars earned, and then by adding the CPIS tax-exempt interest payments received by the CRAT over the term of the CPIS ($1,165,000*5.00%*10 years=$582,500) the Contributor is able to create additional funds that are not subject to income tax that could be applied towards an additional 50% in charitable gifting ($582,500/$1,165,000=50%).

If the Contributor were to choose to use its tax-exempt interest payments upon distribution from the CRAT to make additional charitable gift contributions, again based on the information in the example above, it could then increase its overall leverage and gift giving ability by 90% in comparison to its gifting without using the CPIS investment structure.

This calculation converts the tax-exempt interest received over the term of the CPIS into taxable income at the Contributor's Income Tax Rate, assuming the Contributor is an individual in the 35% federal income tax bracket plus is a California State resident subject to the State's 9.3% personal income tax bracket for a combined tax rate of 44.3%, ($582,500/(1-44.3%)=$1,045,781) that when added to the initial investment ($1,165,000) amounts to taxable equivalent income of $2,210,781.

This indicates that the Contributor in CPIS would have needed to earn $2,210,781 of taxable income and gift this amount in order to achieve the same results that it can accomplish by investing $1,165,000 in CPIS as described above.

That amounts to leveraging a Contributor's charitable gift donation by 90% (($2,210,781−$1,165,000)/$1,165,000=90%).

This example demonstrates the significant impact to the entire charitable giving industry as a result of CPIS.

Another example to describe how CPIS can be applied examines how the charitable organization, as the Borrower, and the Contributor, as investor and donor, both benefit.

In this example the Borrower, a non-profit organization, seeks to raise $10,000,000 to purchase land on which it desires to construct a new building. The Borrower elects to issue taxable CPIS for a 10-year term at a fixed interest rate of 7.0% with interest payable on a quarterly basis. It is determined that to raise this amount for its purpose, the Borrower will need to issue $11,495,000 in CPIS to provide for the additional costs of reserves and all other transaction costs. It is further assumed that since this is a taxable issuance that there is no need for an additional Issuer, so the Borrower in this case is also the Issuer.

The Borrower would expect to pay debt service for this CPIS issuance totaling $804,650 ($1.1,495,000*7.0%) per annum plus an additional amount per annum for related transaction costs equal to $91,960 for a total annual obligation of both debt service and fees equal to $896,610 ($804,650+$91,960). It should be noted that within the $11,495,000 of CPIS, there is a one year reserve equal to $804,650 that is being set aside that can be used by the Borrower towards its final debt service payment or to receive from the CPIS Trustee upon the final debt service payment being made and the CPIS being no longer outstanding.

In comparison, the Borrower could expect to pay something near $1,272,800 per annum if it were to receive another type of loan for only $10,000,000, assuming this loan were to be amortized over a similar 10-year term, where the $1,272,800 would reflect payment of both principal and interest with the interest rate assumed at an even lower rate of 5.0% versus 7.0% being assumed for CPIS. This also implies that the Borrower would need to come up with other sources of cash to cover any additional costs associated with this loan, since their need was for $10,000,000 to complete their project. This comparison demonstrates an annual debt service savings to the Borrower in using CPIS of approximately 30% [($1,272,800−$96,610)/$1,272,800=30%], plus the additional benefit of having the reserves available at the end of the term when using CPIS.

While this speaks to the Borrower needing the funds for their project, now we examine how CPIS affect the Contributor for this same $11,495,000 CPIS funding. The Contributor chooses to set up a CRAT and funds its CRAT with $11,495,000 cash. The CRAT administrator purchases $11,495,000 CPIS by paying the CPIS Trustee in exchange for taxable bonds paying a 7.0% fixed interest rate on a quarterly basis for a 10-year term. The CRAT would receive CPIS taxable interest income of $804,650 in total each year for 10 years.

Upon closing of this CPIS transaction and the CRAT receiving the CPIS, and the CRAT gifting the principal amount of the CPIS back to the Borrower as the beneficiary, the Contributor is now eligible for a charitable gift tax benefit as described above.

The Contributor would be eligible for a tax benefit of $1,726,300. This amount is calculated as follows: $11,495,000 charitable gift*42.91% (the CRAT deduction rate, calculation for rate was described above)*35% federal income tax bracket (assumes Contributor is an individual and CPIS are in a State such as Washington State where there is currently no personal income tax).

In addition to the tax benefit, the Contributor would expect to receive from the CRAT the $804,650 in annual income from the interest received from the CPIS debt service payments made by the Borrower. Assuming no additional interest is earned on this interest income, the Contributor would receive a total of $8,046,500 over the 10 year term.

If the Contributor and/or the CRAT is to reinvest this interest income as it is received on a quarterly basis during the 10-year term in an investment yielding 4.25% interest it could add an additional benefit totaling $1,880,900 [($804,650*1*4.25%)+(($804,650*2*4.25%)+($804,650*3*4.25%)+($804,650*4*4.25%)+($804,650*5*4.25%)+($804,650*6*4.25%)+($804,650*7*4.25%)+($804,650*8*4.25%)+($804,650*9*4.25%)+($804,650*10*4.25%)], that when combined with the $8,046,500 in interest income received plus the $1,726,300 in the initial tax benefit would provide a total benefit to the Contributor of $11,653,700 over the 10-year period. This amount reflects income earnings benefiting the Contributor before deductions of personal income tax.

The analysis above reflects the potential for a Contributor to replace its original gift, or its wealth (i.e. wealth replacement), over the term of the CPIS.

The impact to a Contributor's wealth replacement could further be enhanced by applying other investment products such as life insurance, by applying the interest income received toward the premium payments for such a policy.

The Contributor could choose to enhance its charitable giving output by naming the Borrower or other charitable organizations as beneficiary of other investment products such as life insurance, by applying the interest income received toward the premium payments for such a policy.

A Contributor could also choose to combine the above in any manner it deems appropriate.

CPIS further benefit a Contributor from a wealth cost perspective. A Contributor choosing to simply gift cash or appreciable assets, similar to that as described above for CPIS, would receive a tax benefit for its gift donation at its appropriate individual or corporate income tax bracket.

In continuing with the example above for the Contributor being an individual, the tax benefit would be 35% and the wealth cost would be 65%. If the Contributor's gift was for $10,000,000 then its wealth would be lessened after the 35% income tax benefit of $3,500,000 ($10,000,000*35%) by $6,500,000 ($10,000,000−$3,500,000).

Were the Contributor to use the taxable CPIS structure as described above, its wealth cost would be much less at only $2,625,600 or 23% of the $11,495,000 gift ($2,625,600/$11,495,000=23%). This figure of $2,625,600 ($11,495,000−$1,726,300−$7,143,100=$2,625,600) assumes the Contributor funds $11,495,000 for CPIS, receives an initial tax benefit of $1,726,300, and earns $7,143,100 by using a net present value factor of 3.0% against the interest income received from the CPIS plus the reinvestment of the interest income received over the 10-year term without applying any associated income tax deductions on the interest income.

If income tax deductions at a 35% rate are applied to the interest income identified immediately above, then the wealth cost would be lower at $5,035,200 or 44% of the $11,495,000 gift ($5,035,200/$11,495,000=44%). This wealth cost amount is calculated as follows: $11,495,000 (the original gift amount and amount of CPIS)—$1,726,300 (the initial tax benefit)—$4,733,500 (the after tax net present value amount, assuming a 3.0% net present value rate, of total CPIS interest earned and reinvested over the term). This 44% wealth cost provides a savings to a Contributor of 32% [(65%−44%)/65%] versus had the Contributor simply gifted a donation amount of $10,000,000 at a wealth cost of 65%.

The impact is much greater when using tax-exempt CPIS. Had this example been based on tax-exempt CPIS, a lower CPIS interest rate would have been assumed, resulting in the overall benefits to the Contributor being greater, as well as enhanced benefits to the Borrower in lower debt service payments over the term.

CPIS offers Contributors the ability to support charitable organizations at the lowest cost burden to the Borrower compared to other debt structures and with multiple benefits to the Contributors as evidenced above that provide for a win-win outcome for the charitable organization, its Contributors and its community.

After a CPIS issuance has closed and the Borrower has taken ownership of the Project (in the event of an acquisition), the Borrower will ultimately be responsible for maintaining continuing disclosure of the performance of the Project and for making the obligated payments as due, both as required by the legal documents established for the CPIS. The Borrower may choose to use the services of an Asset Manager to assist it for this purpose.

The Borrower will further be responsible for maintaining the Project in a manner that is consistent with the Borrower's charitable purpose in order to protect against the Internal Revenue Service, or any other federal and/or state agency, in finding it to be in violation of its charitable purpose thereby causing its charitable status to be revoked.

Upon the maturity and termination of the CPIS, the Borrower will no longer be held responsible for the reporting requirements established by the CPIS legal documents; however, it is expected that the Borrower will continue to remain in good standing as a charitable organization and regarding its maintaining the Project in a manner that is consistent with its charitable purpose.

Furthermore, CPIS differs from other gift products in that with CPIS the charitable organization receives the capital it needs for its Project up-front versus having to wait for an event of the Contributor to occur, such as death or other event.

Use of CPIS structure provides a unique opportunity otherwise unavailable, and stands to transform the financial industry, namely the capital markets and philanthropic markets, and the manner in which charitable organizations raise funds for their Projects, using the capital markets, and in which Contributors, as philanthropists, gift money to support charitable organizations.

1. A method, for a Borrower to use debt financing to fund a Project without the need to repay the principal amount of the debt.

2. A method, for a Borrower to use debt financing in method 1 whereby its obligation of debt service consists solely of interest payments based on the principal amount of the debt issuance, for a fixed term, with no requirement to repay the principal amount.

3. A method, for a Borrower to effect a lower cost of capital in comparison to traditional debt financing whereby their debt service obligation would include payment of both interest and principal of the debt issuance amount.

4. A method, using trust vehicles to fund debt issuances by Borrowers (charitable organizations) in order to fund Projects and/or other applications.

5. A method, using a trust as a vehicle by which a Contributor funds the purchase of CPIS.

6. A method, of using a fixed term Charitable Remainder Annuity Trust, funded by a Contributor, as a vehicle to purchase CPIS for the benefit of a Borrower.

7. A method, using said methods 4, and/or 5, and/or 6 that enables Borrowers to benefit from lower borrowing costs versus other debt issuance.

8. A method, using said methods 4, and/or 5, and/or 6 and/or 14 and/or 16 that enables Contributors to enhance their charitable giving opportunities.

9. A method, using said methods 4, and/or 5, and/or 6 and/or 13 and/or 15 that enables Contributors to replenish their wealth through the reinvestment of interest income derived from CPIS in addition to making a charitable gift that benefits a Borrower.

10. A method, using said methods 4, and/or 5, and/or 6 that enables Contributors to minimize their wealth cost in comparison to making a gift of cash and/or appreciable assets to a charitable organization.

11. A method, for a Contributor to make a charitable gift to a charitable organization (a Borrower) by purchasing CPIS whereby the proceeds of the CPIS are used by a Borrower in a manner that is supportive of its charitable purpose.

12. A method, for a Contributor to benefit from a charitable gift tax deduction by gifting the principal amount (all or a portion thereof) of CPIS to the Borrower, and continue to benefit from receiving interest payments that are determined as to their amount based on the CPIS principal amount over the term of the CPIS.

13. A method, using said method 12 that enables Contributors to apply the interest received from CPIS towards the payment of premiums for the purchase of life insurance policies (of any type) or other insurance products.

14. A method, using said method 13 that enables a Contributor to make greater charitable gifts to charitable organizations by naming a charitable organization as the beneficiary of the insurance policy or insurance policies.

15. A method, using said method 12 that enables Contributors to apply the interest received from CPIS towards the purchase of other investments, financial or otherwise.

16. A method, using said method 15 that enables a Contributor to make greater charitable gifts to charitable organizations by naming a charitable organization as the beneficiary of the other investments, financial or otherwise.
